(19) United States
(12) Patent Application Publication
(10) Pub. No.: US 2013/0122234 A1
(43) Pub. Date: May 16, 2013

(54) PRECAST VENEER PANEL ARRANGEMENT

(71) Applicant: GERARD G. GREMION, MEXICO CITY (MX)

(72) Inventor: GERARD G. GREMION, MEXICO CITY (MX)

(21) Appl. No.: 13/295,940

(22) Filed: Nov. 14, 2011

(51) Int. Cl. B32B 3/06; B32B 3/10

(52) U.S. Cl. 428/44; 428/131; 428/58; 428/99

(57) ABSTRACT

A precast or prefabricated precast veneer panel which may have an external surface configured to simulate any desired appearance such as field stone, brick, wood paneling or the like and which may be installed in a longitudinal and lateral array of a plurality of such panels and mounted on a preselected surface of a building.

### BACKGROUND OF THE INVENTION

1. Field of the Invention

This invention relates to the construction art and more particularly to the precast panel that may be installed in a two dimensional array of such panels on the surface of a wall, floor or ceiling of a building and on such surfaces both on the inside or outside of a building.

2. Description of the Prior Art

Precast and prefabricated veneer panels have long been utilized in the construction industry to provide a preselected simulated appearance to walls, floors and ceilings both on the exterior and the interior of a building. The use of such precast or prefabricated veneer panels has lowered the cost of providing the desired preselected appearance. For example, the precast or prefabricated veneer panel may provide on the outer surface of the panel a simulated field stone, simulated brick, simulated wood panels and the like. The inner surface of such panels is mounted on the desired surface of the building in a two dimensional array of multiple panels covering the desired building surface.

Many of the precast or prefabricated veneer panels heretofore utilized were provided with some form of interconnecting side edges and end edges. Such prior veneer panels often incorporated conventional or modified tongue and groove, dovetail, mitred half lap, cross lap, dovetail lap interconnections and the like between the panels. Each panel was often attached to the building surface by adhesive, wiremesh, thinset (mortar), scratch coat methods, through bolts, or the like. These methods of installation were costly and time consuming and often required, because of the weight associated with the prior panels, some structural modifications to the wall, ceiling, floor or the like to which the panels were attached. These prior veneer panels often did not allow for rapid or convenient assembly into the desired two dimensional array and required careful and time consuming manipulation of a panel in interconnecting the panel to an adjacent panel or panels. Further, such interconnections as previously utilized often allowed some moisture to seep through the interconnected joint and onto the building surface.

Thus, it has long been desired to have a precast or prefabricated veneer panel that eliminates the prior time consuming and costly panel installation methods and also eliminates the need for structural modifications to the underlying surface on which the pane is installed. It has also long been desired to have such panels which may be quickly and easily assembled into a two dimensional array on a preselected building surface and in which each panel may be selectively and quickly attached to the desired surface. It is further desired that the interconnections between adjacent panels minimize or eliminate the seepage of water from the outer surface of the panels through the interconnections to the surface on which the panels are mounted.

### SUMMARY OF THE INVENTION

Accordingly, it is an object of the present invention to provide an improved precast or prefabricated veneer panel that may be rapidly and easily mounted on a preselected building surface in a two dimensional array of panels.

It is another object of the present invention to provide an improved precast or prefabricated veneer panel that may be rapidly and easily mounted on a preselected building surface in a two dimensional array of panels and that may be securely and rapidly mounted on the building surface and that minimizes or eliminates the seepage of moisture through the interconnections onto the building surface.

It ids another object of the present invention to an improved precast or prefabricated veneer panel that may be rapidly and easily mounted on a preselected building surface in a two dimensional array of panels and that may be rapidly and easily mounted on a preselected building surface in a two dimensional array of panels and which can provide a variety of outer surface configurations.

The above and other objects of the present invention a re achieved, in a preferred embodiment thereof by providing a precast veneer panel that may be mounted on a building surface in a two dimensional array of similar panels. Each of the panels has a body member which has a central portion, a planar lower surface and upper surface, both of which extend over the central portion. The upper surface may have any desired configuration to simulate a desired external appearance. The lower surface if the body member is generally planar for close abutment onto the preselected building surface. Each of the panels in the array are substantially identical but in some applications it may be necessary to trim one or more panels so that the array fits into the boundaries of the surface on which the array is mounted.

The body member of each panel has a first side edge which has plurality of first side edge surfaces. Each of the first side edge surfaces is at a preselected angle to a medial plane which extends throughout the central portion of the body member and is substantially parallel to the planar lower surface. The body member also has a second side edge which has a plurality of second side edge surfaces that are a mirror image of the first side edge surfaces so that the first side edge of one panel may securely mate with the second side edge of an adjacent panel.

One of the first side edge surfaces has a plurality of spaced apart apertures extending into the central portion a preselected distance and the apertures are configured to be countersunk screw head accepting apertures which have a bottom surface defining pilot hole. The apertures are oriented at a preselected angle with respect to the lower surface and the angle may be in the range of 30 degrees to 45 degrees. Each panel is mounted on the building surface by drilling out the aperture from the pilot hole at the preselected angle through the central portion of the body member and then driving a screw or similar fastening device through the apertures, through the central portion of the body member and into the structure having the preselected building surface on which the panels are mounted.

Each of the panels also has a first end edge and a second end edge, both of which have a plurality of surfaces. The end first end edge surfaces and the second end edge surfaces may, in some preferred embodiments of the invention, define an end lap joint for joining the first end edge of a firs panel to the second end edge of an adjacent panel in the array of panels.

### BRIEF DESCRIPTION OF THE DRAWING

The above and other embodiments of the present invention my be more fully understood from the following detailed description taken together with the accompanying drawing wherein similar reference characters refer to similar elements throughout and in which:

FIG. 1 illustrates an exploded two dimensional array of four panels, each of the panels according to the principals of the present invention.

FIG. 2 is a partial exploded sectional view taken along the line 2-2 of FIG. 1 and illustrates the interconnection of the side edges of two adjacent panels;

FIG. 2A, 2B, 2C, 2D, and 2E illustrate details of the first side edge surfaces shown in FIG. 2;

FIG. 2F is an enlarged view of the portion indicated at 2F on FIG. 2;

FIGS. 3A, 3B and 3C illustrate the details of the second side edge shown in FIG. 1;

FIG. 4 is a partial exploded sectional view taken along the line 4-4 of FIG. 1 and illustrates the interconnection of the end edges of two adjacent panels;

FIG. 5 illustrates the interconnection of the side edges of two adjacent panels of another embodiment of the present invention; and,

FIG. 6 illustrates a sectional view of two panels according to the principles as installed on a vertical wall.

### DESCRIPTION OF THE PREFERRED EMBODIMENTS

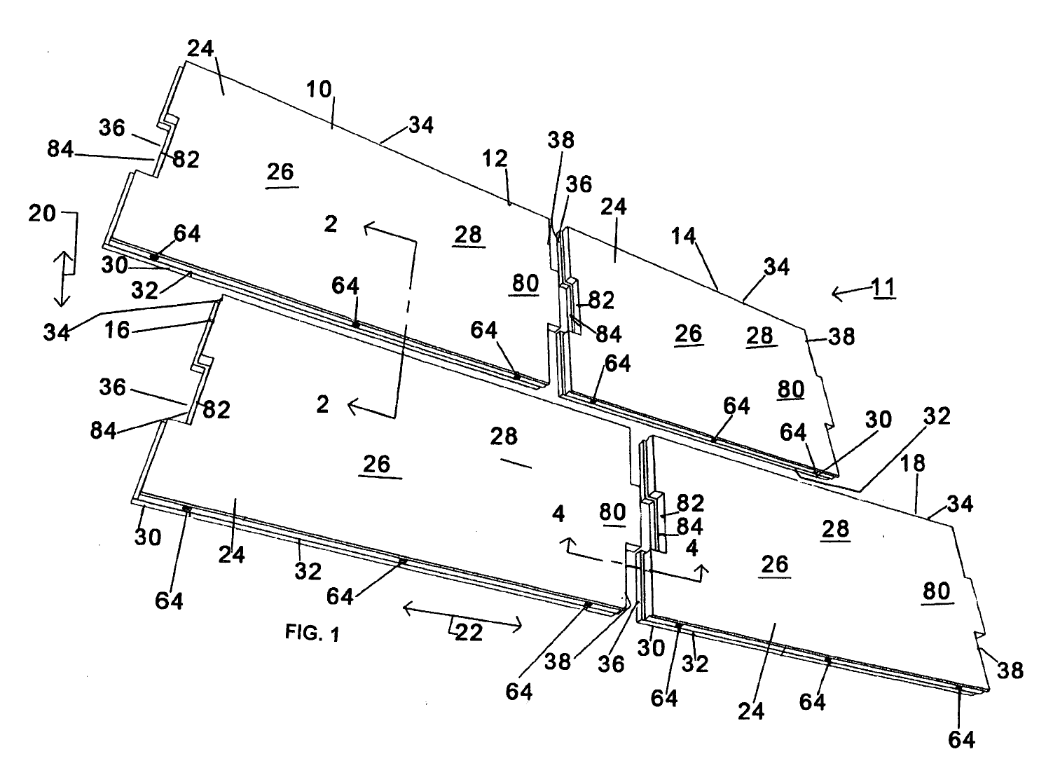

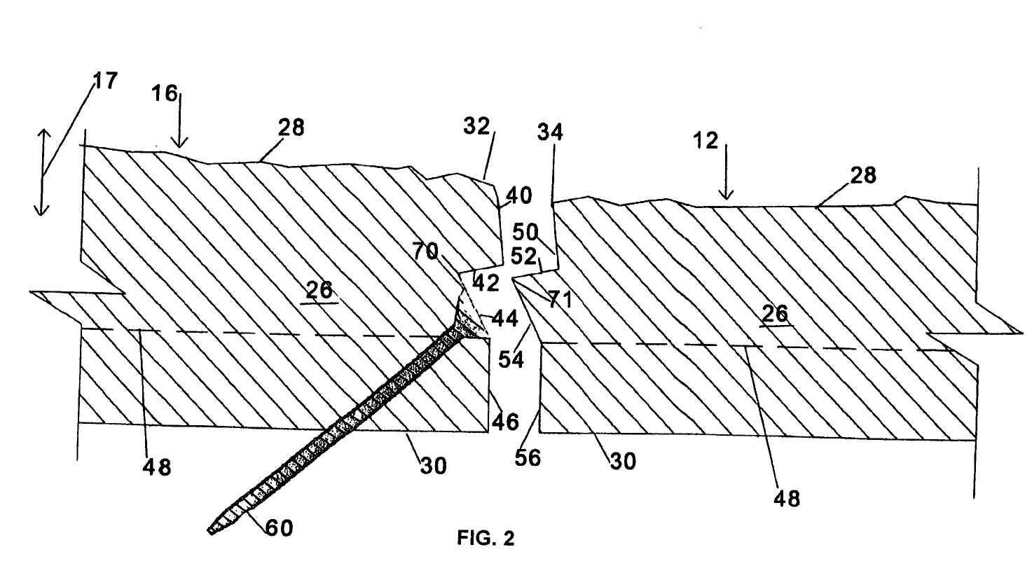

Referring now to the drawing, there is shown on FIG. 1 an exploded perspective view of a two dimensional array 10 of a embodiment 11 of precast veneer panels 12, 14, 16 and 18 extending in a longitudinal direction indicated by the double ended arrow 20 and a lateral direction indicated by the arrow 22. The designations “longitudinal” and “lateral” (as well “transverse” as described below) are for convenience in describing the structural elements of the present invention and are not indicative of directional relationships as the present invention may be installed on vertical as well as horizontal surfaces. Each of the precast veneer panels 12, 14, 16 and 18 are substantially identical in the embodiment 10. The showing on FIG. 1 of the four precast veneer panels is illustrative and there may be many more precast veneer panels in an array extending in both the longitudinal direction and the lateral direction.

Each of the precast veneer panels 12, 14, 16 and 18 have a body member 24 having a central portion 26. The central portion 26 has an upper surface 28 and a lower surface 30 spaced transversely from the upper surface 28. The upper surface 28 of each of the precast veneer panels 12, 14, 16 and 18 may be configured to have any desired ornamentation such as simulated field stone, bricks, wood paneling, and the like. Each of the precast veneer panels 12, 14, 16 and 18 have a generally planar lower surface 30 which, as described below, abuts a preselected surface of a building when the array of precast veneer panels is installed. Consequently, in some applications of the present invention the upper surface 28 of each of the precast veneer panels may not be plainer such as those providing a simulated field stone which has an uneven surface. In other applications of the present invention, for the upper surface simulating brick or wood paneling, the upper surface 28 is substantially planar. the upper surface 28 may be painted or otherwise colored as may be desired for particular applications.

Each of the precast veneer panels in the array are precast, in preferred embodiments of the present invention, from a mixture of crushed stone and various types of binders such a polyvinyl chloride, glass fiber or the like to provide a panel that is, for example much lighter in weight than a comparable stone veneer, a brick veneer or the like having the same dimensions.

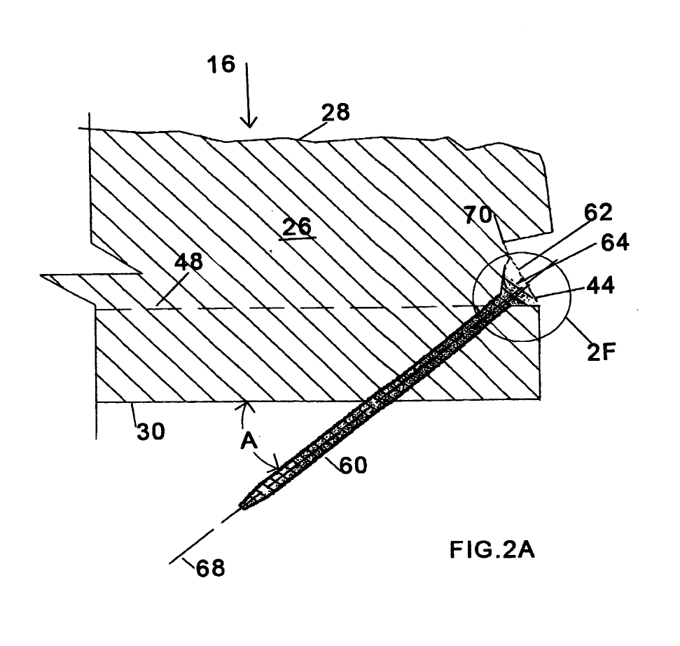

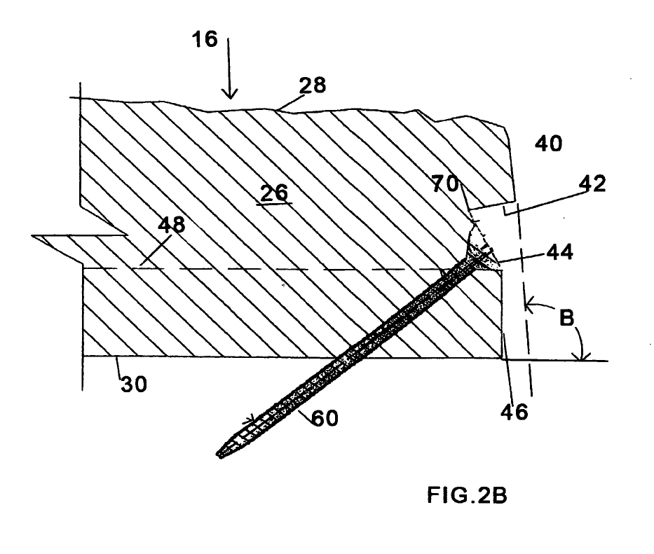

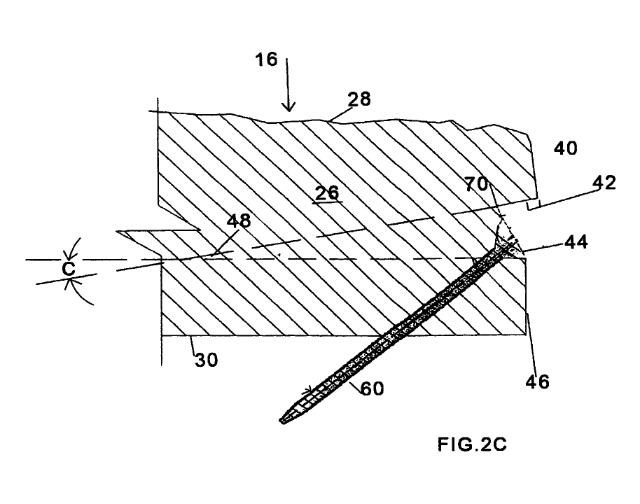

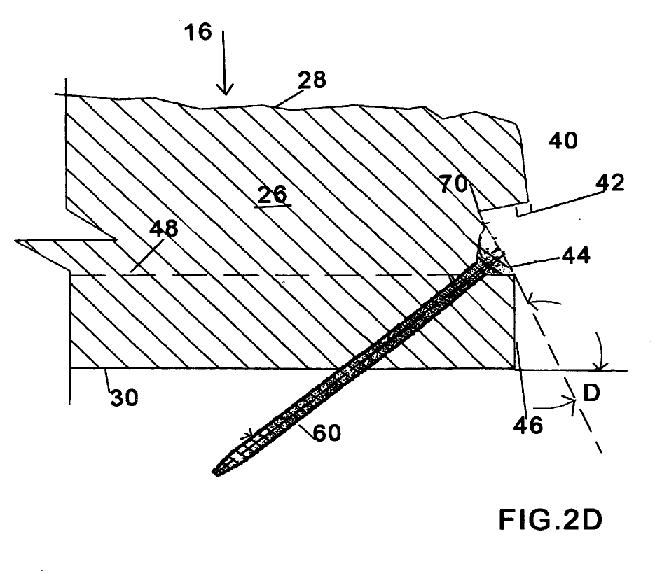

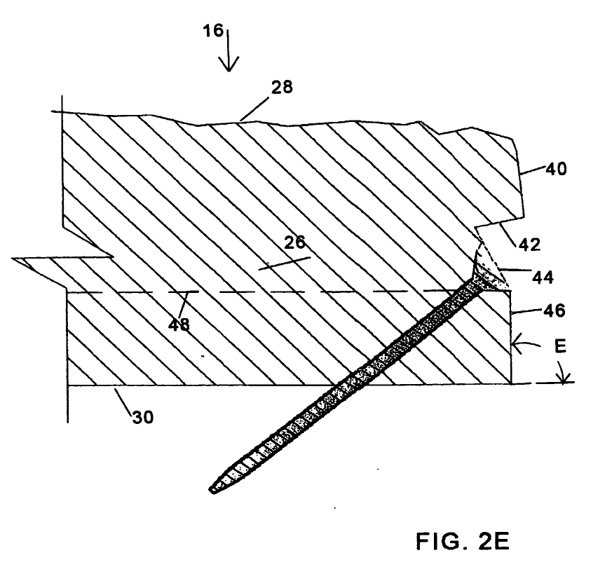

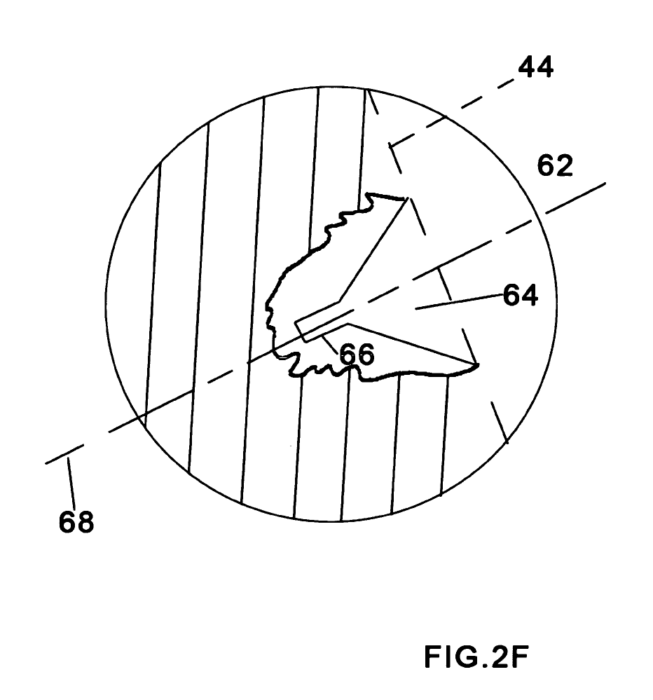

Each of the precast veneer panels 12, 14, 16 and 18 have a first side edge 32, a second side edge 34 spaced longitudinally from the first side edge 32 and extending between the upper surface 28 and lower surface 30. As described below in connection with FIGS. 2, 2A, 2B, 2C, 2D and 2E the first side edge 32 has a plurality if first side edge surfaces which are aligned at preselected angles to the lower surface 30. Each of the second side edges 34 also have a plurality of second side edge surfaces that are a mirror image of the first side edge surfaces so that the first side edge surface of a first precast veneer panel matingly interconnect with the second side edge surfaces of a second precast veneer panel.

Each of the precast veneer panels 12, 14, 16 and 18 have a first end edge 36 and a second end edge 38 laterally spaced from the first end edge and extending from the upper surface 28 to the lower surface 30. Each of the first end edges 36 of each of the precast veneer panels 12, 14, 16 and 18 and each of the second end edges 38 of precast veneer panels 12, 14, 16 and 18 define a half lap splice joint for matingly interconnection with adjacent precast veneer panels.

Referring now to FIG. 2, there is illustrated a partial sectional exploded view of the interconnection between the first side edge 32 of the precast veneer panel 16 and the second side edge 34 of the precast veneer panel 12. Since each of the precast veneer panels of the present invention are made from the same mold or are other wise substantially identical, the description of the interconnection shown on FIG. 2 applies to the interconnection of the side edges of each panel in an array such as the array shown on FIG. 1.

As shown on FIG. 2, the first side edge 32 of precast veneer panel 16 has a plurality of first side edge surfaces: first side edge surface 40, second side edge surface 42, third side edge surface 44 and fourth side edge surface 46. Each of the first, second, third and fourth sided edges 40, 42, 44 and 46 of the first side edge 32 of panel 16 are at a preselected angle to the lower surface 30 and to a medial plane indicted at 48 which is parallel to the planar lower surface 30 of each of the panels 16 and 12. The angular relationship of each of the surfaces 40, 42, 44 and 46 are discussed below in connection with FIGS. 2B, 2C, 2D and 2E. the lower surface 30 is transversely spaced from the upper surface 28 as indicated by the double ended arrow 17.

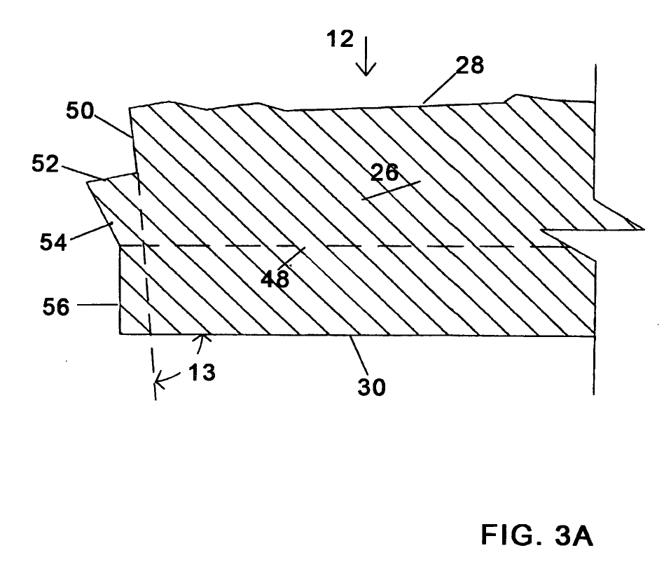

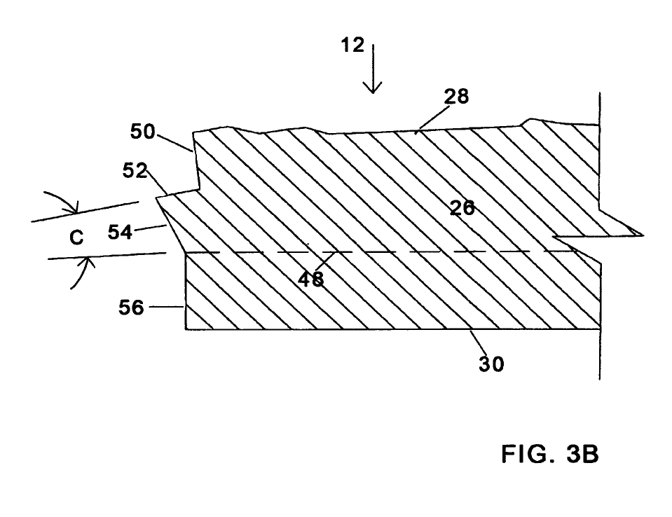

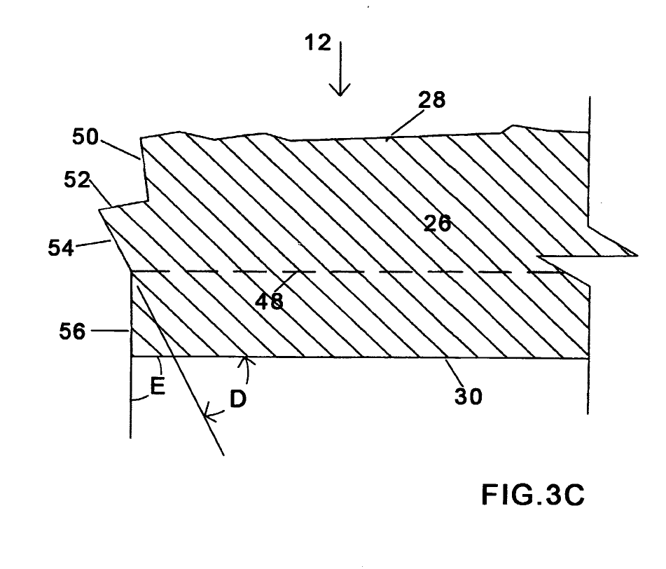

The second side edge 34 of panel 12 is a mirror image of the first side edge 32 of panel 16 so as to provide an mating interconnection therebetween and the second side edge 34 has a plurality second side edge surfaces 50, 52 54 and 56 which, for the condition of the panel 16 mated to the panel 12, are in abutment with the first side edge surfaces 40, 42, 44 and 46, respectively. The angular relationship of the second side edge surfaces 50, 52 and 54 are described below in connection with FIGS. 3A, 3B and 3C.

FIG. 2 shows a screw or nail 60 extending through surface 44, through the body portion 26 and through the lower surface 30 to project therefrom. The screw or nail 60 is utilized in preferred embodiments of the present invention to attach the panels to the preselected surface of the building. As shown on FIG. 2a, the screw or nail 60 is at a preselected angle A to the lower surface. The preselected angle A is in the range of 25 degrees to 45 degrees and preferably the angle A may be 30 degrees. The angle selected may be an angle that is compatible with the building surface to which the panel is attached to provide secure retention of the panel thereon.

The surface 44 has walls 62 defining a screw head counter sunk aperture 64 as shown in enlarged view on FIG. 2F. The aperture 64 does not extend through the panel in the as cast or prefabricated panel. The aperture 64 terminates in a pilot hole or cavity 66 aligned along the axis 68 which is at the angle A in the panel 16. When the panel 16 is installed on the preselected surface of a building, the screw or nail 60 is inserted into the aperture 64 and pilot hole 66 so that the screw or nail 68 is aligned at the angle A as it extends through the body portion 26 and out of the lower surface 30.

FIG. 2B shows the surface 40 extending at an angle B to the lower surface 30 and medial plane 48. The angle C is in the range of 75 degrees to 85 degrees.

FIG. 2C shows the surface 44 extending at an angle C to the lower surface 30 and medial plane 48. The angle C is in the range of 5 to 20 degrees.

FIG. 2D shows the surface 44 extending at an angle D to the lower surface 30 and medial plane 48. The angle D is in the range of 50 to 60 degrees. As shown on FIGS. 2, 2A, 2B, 2C and 2D, as indicated at 70 the intersection of the surfaces 42 and 44 provides a linear alignment. Similarly, the intersection 71 of surfaces 52 and 54 provide a linear alignment.

FIG. 2E shows the surface 46 extending at an angle E to the lower surface 30 and medial plane 48. The angle E is substantially at right angles or 90 degrees to the medial plane 48 and lower surface 30.

As noted above, the second side edge surfaces 50, 52, 54 and 56 of the panel 12 are the mirror images of the first side edge surfaces 40, 42, 44 and 46, respectively to allow the mating interconnection therebetween.

FIG. 3A shows the surface 50 extending at the angle B to the medial plane 48 and lower surface 30.

FIG. 3B shows the surface 52 extending at the angle C to the lower surface 30 and medial plane 48.

FIG. 3C shows the surface 54 extending at the angle D to the lower surface 30 and medial plane 48 and also shows the surface 56 extending at the angle E to the medial plane 48 and lower surface 30.

As shown on FIG. 1, in preferred embodiments of the present invention, the second end edge 38 of each of the panels 12, 14, 16 and 18 have a first portion 80 extending outwardly from the central portion 26 of body member 24. The first end edge 36 of each of the panels 12, 14, 16 and 18 have walls 82 defining a cavity 84 which is configured to accept the portion 80. I n other preferred embodiments of the present invention, the first end edge 36 and second end edge 38 are linear and do not have either a projecting portion or a cavity.

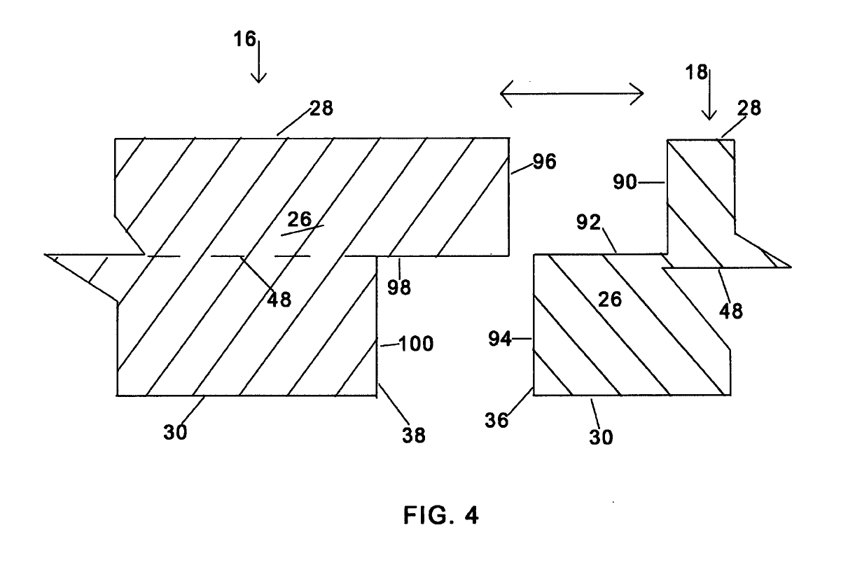

FIG. 4 is a partial sectional view along the line 4-4 of FIG. 1. As shown on FIG. 4, the first end edge 36 of panel 18 has a plurality of surfaces 90, 92 and 94. The surfaces 90 and 94 may, in preferred embodiments of the present invention, extend at right angles or 90 degrees to the medial plane 48 and lower surface 30. The surface 92 is parallel to the lower surface 30 and in the panels 12, 14, 16 and 18 the surface 92 is along the medial plane 48.

The second end edge 38 has a plurality of surfaces 96, 98 and 100 that are mirror images of the surfaces 90, 92 and 94, respectively to provide a half lap splice joint for the mating of the first end surfaces of one panel with the second end surface of a second panel. In other embodiments of the present invention, other types of joint configuration may be utilized in the end edges of the panels as desired for particular applications.

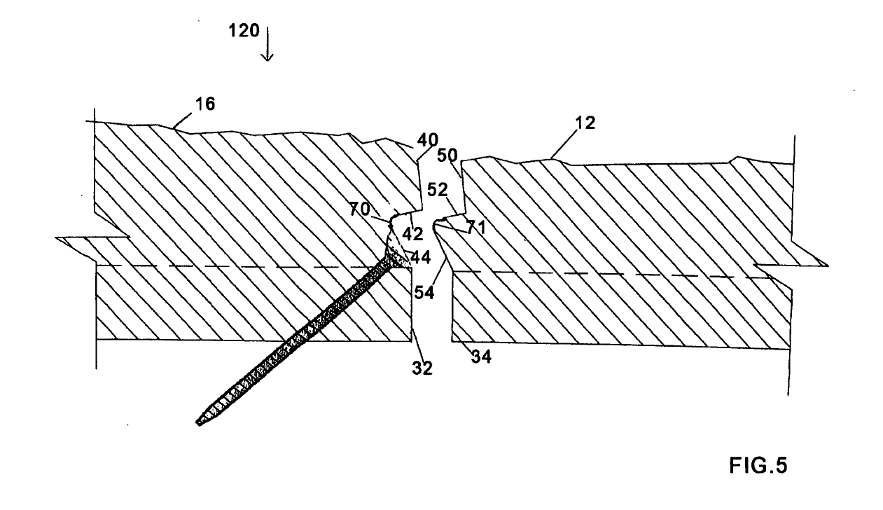

FIG. 5 illustrates another preferred embodiment 120 that is generally similar to the embodiment 10. In the embodiment 120 the intersection of the surfaces 42′ and 44′ of first side edge 32′ of a precast veneer panel 16′ which may be similar to the precast veneer panel 16 is rounded as indicated at 70′. Similarly, the intersection of the surface 52′ and 54′ of second side surface 34′ of precast veneer panel 12′ which may be similar to the precast veneer panel 12, is rounded as indicated at 71′ to matingly interconnect with the rounded intersection 70′.

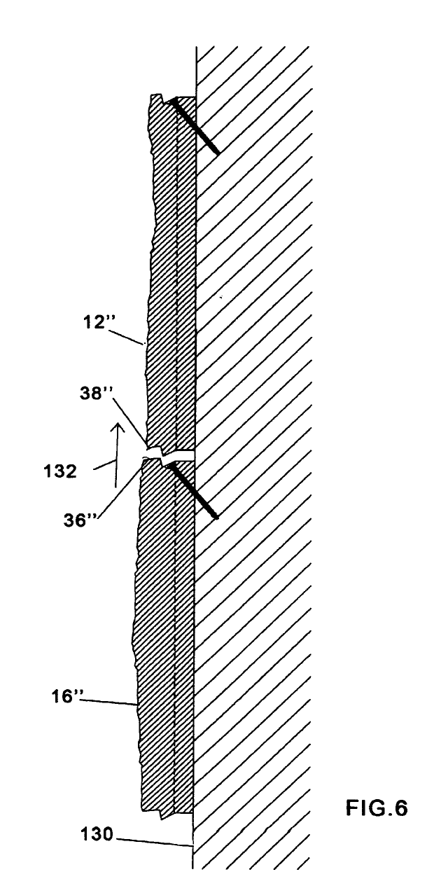

FIG. 6 illustrates two precast veneer panels 16″ and 12″ which may be similar to the precast veneer panels 16 and 12 according to the principals of the present invention installed on a preselected surface 130 of a building. In FIG. 6, the surface 130 is a wall surface that extends in the vertical direction as indicated by the arrow 132. The precast veneer panel 16″ is shown, for convenience of illustration, on FIG. 6 as separated from the precast veneer panel 12″ but in actual installations, the second side surface 38″ of panel 12″ is matingly interconnected to the first side surface 36″ of precast veneer panel 16″. The preselected surface 130 upon which the precast veneer panels 12″ and 16″ are installed may be walls, floors, ceilings and may be at any angle to the vertical as may exist in the building.

Although specific embodiments of the present invention have been described above with reference to the various Figures of the drawing, it should be understood that such embodiments are by way of example only and merely illustrative of but a small number of the many possible specific embodiments which can represent applications of the principles of the present invention. Various changes and modifications obvious to one skilled in the art to which the present invention pertains are deemed to be within the spirit, scope and contemplation of the present invention as further defined in the appended claims.

What is claimed is:

1. In a precast veneer panel, the improvement comprising, in combination:
a body member, said body member having:
a central portion;
an upper surface on said central portion;
a lower surface on said central portion spaced from said upper surface in a transverse direction and defining a body volume therebetween, and said lower surface substantially planar;
a first side edge between said upper surface and said lower surface and defining a plurality of first side edge surfaces;
a second side edge between said upper surface and said lower surface and spaced in a longitudinal direction from said first side edge and defining a plurality of second side edge surfaces;
a first end edge between said upper surface and said lower surface;
a second end edge between said upper surface and said lower surface and spaced from said first end edge in a lateral direction, and said first end edge and said second end edge extending from said first side edge to said second side edge;
said upper surface of said body member having a preselected surface ornamentation configuration;
said lower surface of said body member substantially planar;
a medial plane between said upper surface and said lower surface and said medial plane substantially parallel to said lower surface of said body member;
first aperture walls defining a plurality of spaced apart apertures in one of said plurality of first side edge surfaces of said body member, and at least a first group of said plurality of apertures extending into said one of said plurality of first side edge surfaces, at a preselected angle other than 90 degrees to said lower surface of said body member.

2. The arrangement defined in claim 1 wherein:
each of said end edges have a staggered configuration;

3. The arrangement defined in claim 2 wherein:
a first of said end surfaces of said body member having a first portion thereof extending outwardly in said longitudinal direction away from other portions of said first end surface;
a second of said end surfaces of said body member having a second portion thereof extending inwardly in said longitudinal direction away from other portions of said second end surface and toward said first end surface.

4. The arrangement defined in claim 1 wherein:
said preselected angle is in the range of 25 degrees to 45 degrees.

5. The arrangement defined in claim 1 wherein:
said preselected surface ornamentation of said upper surface of said body member is simulated field stone.

6. [symbol]
said preselected surface ornamentation of said upper surface of said body member is simulated wood paneling

7. The arrangement defined in claim wherein:
said plurality of apertures in said one of said first and said second edge surfaces are countersunk apertures for accepting the head of a mounting screw.

8. The arrangement defined in claim 1 wherein:
said preselected angle of said first group of said plurality of apertures is in the range of 10 degrees to 70 degrees from said planar bottom surface of said body member.

9. The arrangement defined in claim 8 wherein:
said preselected angle of said first group of said plurality of apertures is approximately 30 degrees from said planar bottom surface of said body member.

10. The arrangement defined in claim 1 wherein:
a first of said plurality of first side edge surfaces extends a first preselected distance downwardly from said upper surface of said body member toward said lower surface to an outward tip and outwardly from said body volume at an angle in the range of 75 degrees to 85 degrees to said medial plane;
a second of said plurality of first side edge surfaces extends a second preselected distance downwardly from said tip of said first of said plurality of first side edge surfaces toward said lower surface to an inward tip and inwardly toward said body volume at an angle in the range of 5 degrees to 20 degrees to said medial plane;
a third of said plurality of first side edge surfaces extends a third preselected distance downwardly from said inward tip of said second of said plurality of first side edge surfaces toward said lower surface to a medial tip and outwardly from said body volume at an angle in the range of 50 degrees to 60 degrees to said medial plane;
a fourth of said plurality of first side edge surfaces extends a fourth preselected distance downwardly from said medial tip to said lower surface at an angle of substantially 90 degrees to said medial plane; and,
said plurality of apertures in said third of said plurality of first side edge surfaces.

11. The arrangement defined in claim 10 wherein:
said plurality of second side edge surfaces are a mirror image of said plurality of first side edge surfaces and free of any apertures extending therethrough.

12. The arrangement defined in claim 11 wherein:
a plurality of said body members arranged in a longitudinal array;
whereby said first side edge of a first of said plurality of body members sealingly fits into said second side edge of a second of said plurality of body members.

13. The arrangement defined in claim 12 wherein:
said inward tip is linear.

14. The arrangement defined in claim 12 wherein:
said inward tip is rounded.

15. The arrangement defined in claim 10 wherein:
said first end edge has a plurality of first end edge surfaces defining a half lap splice joint, and
said second end edge has a plurality of second end edge surfaces comprising a mirror image of said first end edge surfaces, whereby first end surfaces of a first body member may be sealingly joined to second end surfaces of a second body member in a lateral array of body members.

16. The arrangement defined in claim 15 wherein:
said first end edge has at least one portion extending outwardly from said central portion of said body member; and,
said second end edge has at least one recessed portion extending into said central portion of said body member and said second end edge configured to be the mirror image of said first end edge, whereby a first end edge of a first body member may join together with a second end edge of a second body member aligned in a lateral array.

17. In a precast veneer panel, the improvement comprising, in combination:
a body member, said body member having:
a central portion;
an upper surface on said central portion;
a lower surface on said central portion spaced from said upper surface in a transverse direction and defining a body volume therebetween, and said lower surface substantially planar;
a first side edge between said upper surface and said lower surface and defining a plurality of first side edge surfaces;
a second side edge between said upper surface and said lower surface and spaced in a longitudinal direction from said first side edge and defining a plurality of second side edge surfaces;
a first end edge between said upper surface and said lower surface;
a second end edge between said upper surface and said lower surface and spaced from said first end edge in a lateral direction, and said first end edge and said second end edge extending from said first side edge to said second side edge;
said upper surface of said body member having a preselected surface ornamentation configuration;
said lower surface of said body member substantially planar;
a medial plane between said upper surface and said lower surface and said medial plane substantially parallel to said lower surface of said body member;
first aperture walls defining a plurality of spaced apart apertures in one of said plurality of first side edge surfaces of said body member, and at least a first group of said plurality of apertures extending into one of said plurality of first side edge surfaces toward said lower surface to define a countersunk screw head accepting aperture at a preselected angle in the range of 25 degrees to 45 degrees to said lower surface of said lower surface and a pilot hole extending from said screw head accepting aperture into said body member at said preselected angle;
a first of said plurality of first side edge surfaces extends a first preselected distance downwardly from said upper surface of said body member toward said lower surface to an outward tip and outwardly from said body volume at an angle in the range of 75 degrees to 85 degrees to said medial plane;
a second of said plurality of first side edge surfaces extends a second preselected distance downwardly from said tip of said first of said plurality of first side edge surfaces toward said lower surface to an inward tip and inwardly toward said body volume at an angle in the range of 5 degrees to 20 degrees to said medial plane;
a third of said plurality of first side edge surfaces extends a third preselected distance downwardly from said inward tip of said second of said plurality of first side edge surfaces toward said lower surface to a medial tip and outwardly from said body volume at an angle in the range of 50 degrees to 60 degrees to said medial plane;
a fourth of said plurality of first side edge surfaces extends a fourth preselected distance downwardly from said medial tip to said lower surface at an angle of substantially 90 degrees to said medial plane; and,
said plurality of apertures in said third of said plurality of first side edge surfaces;
said plurality of second side edge surfaces are a mirror image of said plurality of first side edge surfaces and free of any apertures extending therethrough;
said first end edge has a plurality of first end edge surfaces defining a half lap splice joint, and
said second end edge has a plurality of second end edge surfaces comprising a mirror image of said first end edge surfaces, whereby first end surfaces of a first body member may be sealingly joined to second end surfaces of a second body member in a lateral array of body members.

18. The arrangement defined in claim 17 and further comprising:
a plurality of said body members arranged in a lateral and longitudinal array whereby first side edges of each panel are sealingly joined to second side edges of a laterally adjacent body members and first end edges of each panel are joined to second end edges of longitudinally adjacent body members.

19. The arrangement defined in claim 18 wherein:
said lateral array of body members is staggered to provide said joined end edges of a first pair of body members intermediate said joined end edges of an adjacent pair of said body members.
